(19) United States
(12) Patent Application Publication
(10) Pub. No.: US 2010/0164674 A1
(43) Pub. Date: Jul. 1, 2010

(54) COMBINED TRANSFORMER AND MULTI-LAMP DRIVING CIRCUIT

(75) Inventors: Ming Yen Wu, Taoyuan County (TW); Ching Chang Hsieh, Taoyuan County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/485,643

(22) Filed: Jun. 16, 2009

(30) Foreign Application Priority Data
Dec. 25, 2008 (TW) 097223299

(51) Int. Cl. H01F 27/28

(52) U.S. Cl. 336/221

(57) ABSTRACT

The invention discloses a combined transformer. The combined transformer includes a first core, a second core, a first primary coil, a first secondary coil, a second primary coil, and a second secondary coil. The first core includes a first side pillar and a second side pillar. The second core includes a third side pillar and fourth side pillar. The first primary coil winds around the first side pillar. The first secondary coil winds around the third side pillar which corresponds to the first primary coil. The second primary coil winds around the second side pillar. The second secondary coil winds around the fourth side pillar which corresponds to the second primary coil. The first core and the second core form a first magnetic path and a second magnetic path. The first primary coil, the first secondary coil, and the first magnetic path form a first transformer. The second primary coil, the second secondary coil, and the second magnetic path form a second transformer. And, the first transformer and the second transformer are connected in series.

### BACKGROUND OF THE INVENTION

1. Field of the Invention

The present invention generally relates to a transformer and a multi-lamp driving circuit, and more particularly to the transformer and the multi-lamp driving circuit needing fewer cores.

2. Description of the Prior Art

In recent years, with the continuous increasing size of liquid crystal display panels, the backlight device including cold cathode fluorescent lamps (CCFL) has been widely applied to provide the high quality light source required by liquid crystal display panels.

However, the most difficult problem the multi-lamp backlight device faces is how to keep the current flowing in each lamp equal to guarantee that the light source provided to the liquid crystal display panel has stable and uniform brightness.

Please refer to FIG. 1A and FIG. 1B. FIG. 1A illustrates a schematic diagram of the multi-lamp backlight device 1 of the prior art. FIG. 1B illustrates a schematic diagram of the transformer 10 of the multi-lamp backlight device 1 of the prior art in FIG. 1A. As shown in FIG. 1A and FIG. 1B, the transformer 10 of the multi-lamp backlight device 1 includes a primary coil 100, a secondary coil 102, cores 104 and 106; the primary coil 100 is wound on the core 104, and the secondary coil is wound on the core 106. Specifically, the structure of the transformer 12 is the same with the transformer 10, so it will not be described again. As shown in FIG. 1A, one end of the secondary side coil 102 and one end of the secondary side coil 122 receive a high-voltage signal 14 respectively, and provide a current to lamps 16 and 17 respectively to make lamps 16 and 17 light. However, since the specifications and the electrical properties of the transformers 10 and 12 will be different in practical manufacture, the currents the secondary side coils 102 and 122 induct will be different as well, which causes the brightness of lamps 16 and 17 non-uniform.

Additionally, it can be seen that the multi-lamp driving circuit shown in FIG. 1A needs four cores to form the transformers 10 and 12; namely, the more cores used in the transformers, the more cost needed in production.

### SUMMARY OF THE INVENTION

The invention discloses a combined transformer, the combined transformer includes a first core, a second core, a first primary coil, a first secondary coil, a second primary coil, and a second secondary coil.

According to an embodiment of the invention, the first core has a first middle pillar, a first side pillar, and a second side pillar, wherein the first middle pillar, the first side pillar, and the second side pillar are connected. And, the second core has a second middle pillar butting to the first middle pillar, a third side pillar butting to the first side pillar, and a fourth side pillar butting to the second side pillar, wherein the second middle pillar, the third side pillar, and the fourth side pillar are connected.

In this embodiment, a first primary coil is wound on the first side pillar of the first core. The first secondary coil is wound on the third side pillar of the second core, and the first secondary coil corresponds to the first primary coil. The second primary coil is wound on the second side pillar of the first core. The second secondary coil is wound on the fourth side pillar of the second core, and the second secondary coil corresponds to the second primary coil.

Wherein, the mutually butted first side pillar and third side pillar, and the mutually butted first middle pillar and second middle pillar will form a first magnetic path; the mutually butted second side pillar and fourth side pillar, and the mutually butted first middle pillar and second middle pillar will form a second magnetic path. Moreover, the first primary coil, the first secondary coil, and the first magnetic path form a first transformer; the second primary coil, the second secondary coil, and the second magnetic path form a second transformer.

Another scope of the present invention is to provide a multi-lamp driving circuit used for a lamp apparatus. The multi-lamp driving circuit includes at least one combined transformer having the above-mentioned structure.

Compared to the prior art, the combined transformer of the invention only needs two cores (a first core and a second core) to form a first transformer and a second transformer, so that the amount of the core can be saved. Additionally, the multi-lamp driving circuit of the invention is formed by using the combined transformer.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1A illustrates a schematic diagram of the multi-lamp backlight device of the prior art.

FIG. 1B illustrates a schematic diagram of the transformer of the multi-lamp backlight device of the prior art in FIG. 1A.

FIG. 2 illustrates a schematic diagram of the combined transformer of an embodiment of the invention.

FIG. 3 illustrates a schematic diagram of the combined transformer of another embodiment of the invention.

FIG. 4A illustrates a schematic diagram of the multi-lamp driving circuit of another embodiment of the invention.

FIG. 4B illustrates a schematic diagram of the multi-lamp driving circuit connected in series in FIG. 4A.

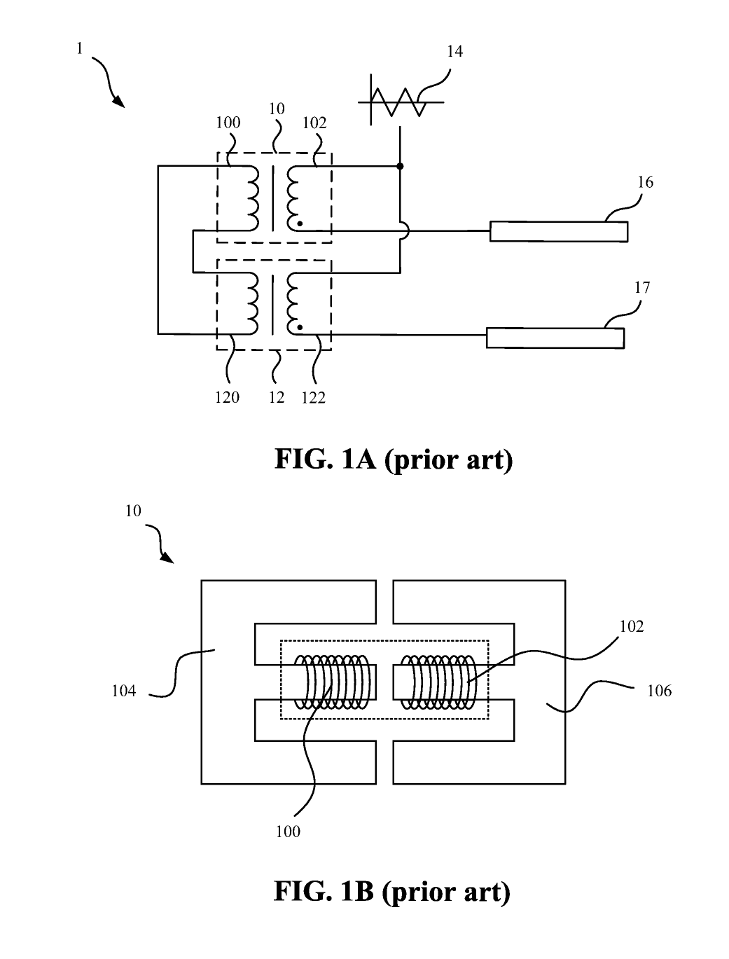

### DETAILED DESCRIPTION OF THE INVENTION

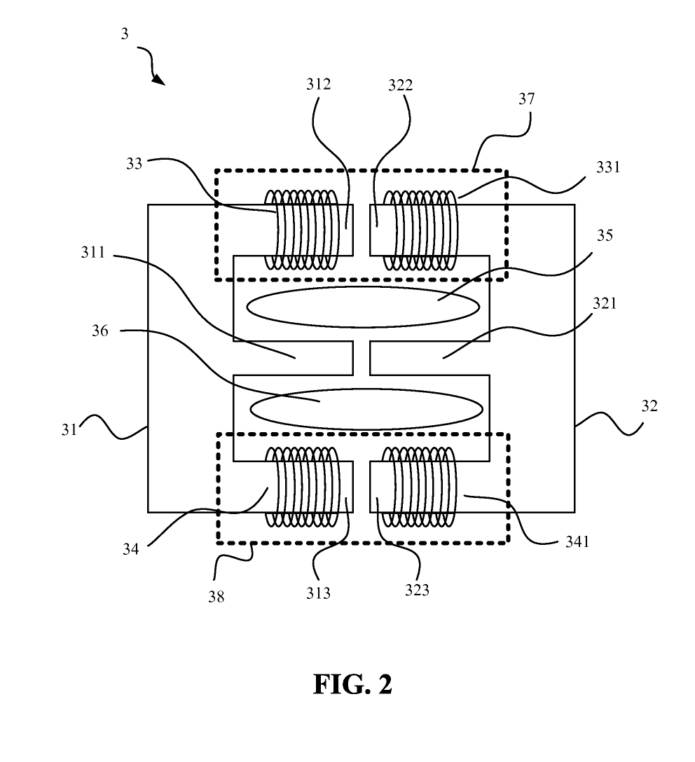

Please refer to FIG. 2. FIG. 2 illustrates a schematic diagram of the combined transformer 3 of an embodiment of the invention. As shown in FIG. 2, the combined transformer 3 of the invention includes a first core 31, a second core 32, a first primary coil 33, a first secondary coil 331, a second primary coil 34, and a second secondary coil 341.

As shown in FIG. 2, in this embodiment, the first core 31 has a mutually connected first middle pillar 311, a first side pillar 312, and a second side pillar 313. The second core 32 has a mutually connected second middle pillar 321, a third side pillar 322, and a fourth side pillar 323. Moreover, the second middle pillar 321 of the second core 32 is butted to the first middle pillar 311 of the first core 31; the third side pillar 322 of the second core 32 is butted to the first side pillar 312 of the first core 31; and the fourth side pillar 323 of the second core 32 is butted to the second side pillar 313 of the first core 31.

As shown in FIG. 2, in this embodiment, the first primary coil 33 is wound on the first side pillar 312 of the first core 31. The first secondary coil 331 is wound on the third side pillar 322 of the second core 32, and the first secondary coil 331 corresponds to the first primary coil 33. Additionally, the second primary coil 34 is wound on the second side pillar 313 of the first core 31. The second secondary coil 341 is wound on the fourth side pillar 323 of the second core 32, and the second secondary coil 341 corresponds to the second primary coil 34.

Similarly, as shown in FIG. 2, the mutually butted first side pillar 312 and third side pillar 322 and the mutually butted first middle pillar 311 and second middle pillar 321 will form a first magnetic path 35; the mutually butted second side pillar 313 and fourth side pillar 323 and the mutually butted first middle pillar 311 and second middle pillar 321 will form a second magnetic path 36. Additionally, the first primary coil 33, the first secondary coil 331, and the first magnetic path 35 will form a first transformer 37. The second primary coil 34, the second secondary coil 341, and the second magnetic path 36 will form a second transformer 38, and the first transformer 37 is connected to the second transformer 38 in series.

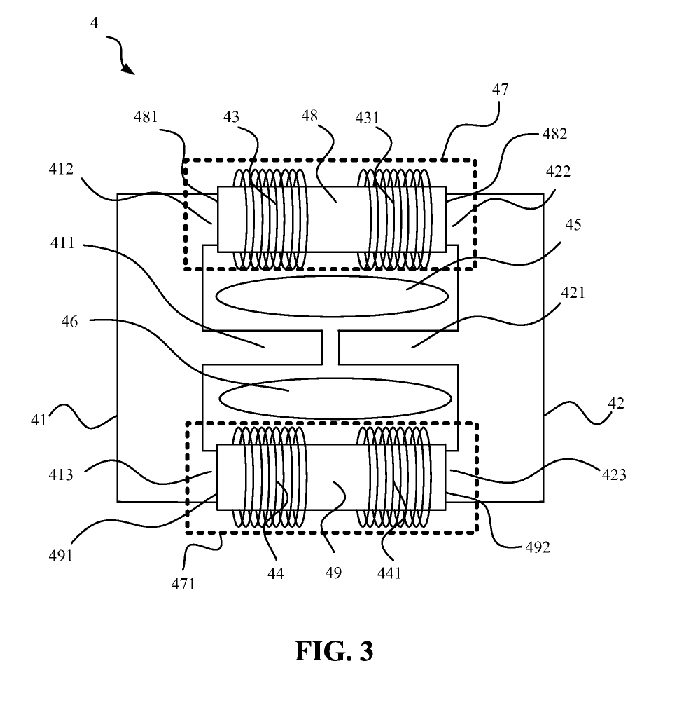

Please refer to FIG. 3. FIG. 3 illustrates a schematic diagram of the combined transformer 4 in another embodiment of the invention. As shown in FIG. 3, the combined transformer 4 of the invention includes a first core 41, a second core 42, a first primary coil 43, a first secondary coil 431, a second primary coil 44, and a second secondary coil 441.

As shown in FIG. 3, in this embodiment, the first core 41 has a mutually connected first middle pillar 411, a first side pillar 412, and a second side pillar 413; the second core 42 has a mutually connected second middle pillar 421, a third side pillar 422 and a fourth side pillar 423. Moreover, the second middle pillar 421 of the second core 42 is butted to the first middle pillar 411 of the first core 41; the third side pillar 422 of the second core 42 is butted to the first side pillar 412 of the first core 41; and the fourth side pillar 423 of the second core 42 is butted to the second side pillar 413 of first core 41.

As shown in FIG. 3, in this embodiment, the first primary coil 43 is wound on a first plastic shell 48 and near a first open 481; the first secondary coil 431 is wound on the first plastic shell 48 and near a second open 482. Additionally, the second primary coil 44 is wound on a second plastic shell 49 and near a third open 491; the second secondary coil 441 is wound on the second plastic shell 49 and near a fourth open 492.

Similarly, as shown in FIG. 3, after the first side pillar 412 and the third side pillar 422 are interposed into the first open 481 and the second open 482 of the first plastic shell 48 respectively; the first side pillar 412 and the third side pillar 422 are mutually butted; and the first middle pillar 411 and the second middle pillar 421 are mutually putted, a first magnetic path 45 will be formed. Additionally, after the second side pillar 413 and the fourth side pillar 423 are interposed into the third open 491 and the fourth open 492 of the second plastic shell 49 respectively; the second side pillar 412 and the fourth side pillar 423 are mutually butted; and the first middle pillar 411 and the second middle 421 are mutually butted, a second magnetic path 46 will be formed. Accordingly, the first primary coil 43, the first secondary coil 431, and the first magnetic path 45 will form a first transformer 47; the second primary coil 44, the second secondary coil 441, and the second magnetic path 46 will form a second transformer 471.

In this embodiment, it is known that the primary coil and the secondary coil are both wound on the plastic shell. And, the side pillar of the core is interposed into the open of the plastic shell to form a transformer.

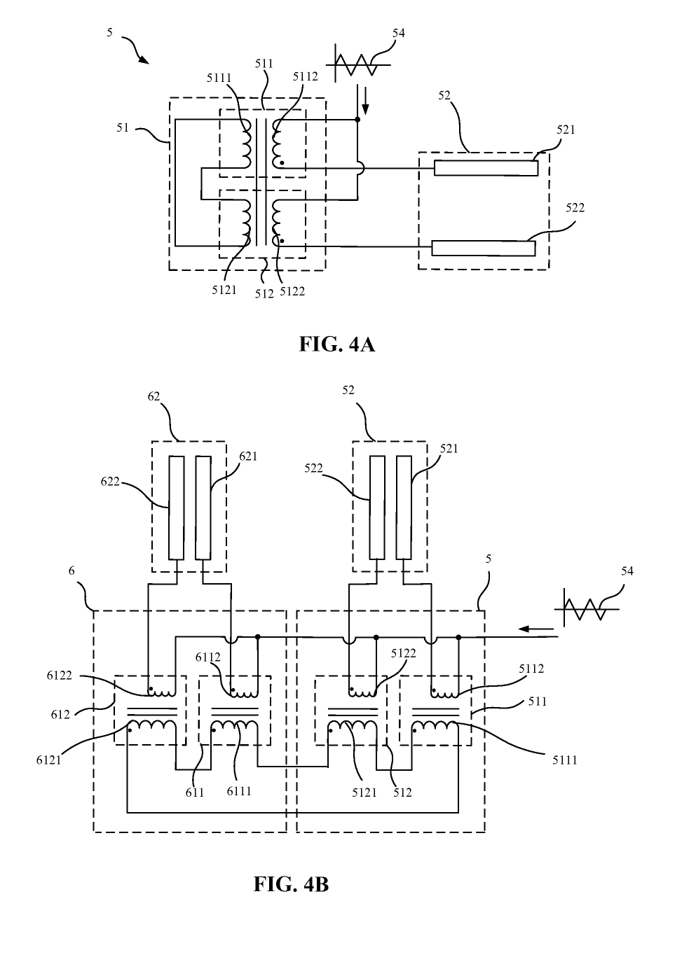

Please refer to FIG. 4A. FIG. 4A illustrates a schematic diagram of the multi-lamp driving circuit 5 of another embodiment of the invention. As shown in FIG. 4A, the multi-lamp driving circuit 5 of the invention includes a combined transformer 51, and the combined transformer 51 can form a first transformer 511 and a second transformer 512. The combined transformer 51 can receive a high-voltage signal to supply a lamp apparatus 52. Specifically, the combined transformer 51 of the multi-lamp driving circuit 5 is used to supply the lamp apparatus 52, thus, only two cores (please refer to FIG. 2 and FIG. 3) are needed to form the first transformer 511 and the second transformer 5 12.

As shown in FIG. 4A, in this embodiment, the first transformer 511 includes a first primary coil 5111 and a first secondary coil 5112 corresponding to the first primary coil 5111; the second transformer 512 comprises a second primary coil 5121 and a second secondary coil 5122 corresponding to the second primary coil 5121. The first primary coil 5111 and the second primary coil 5121 are connected in series.

As shown in FIG. 4A, the lamp apparatus 52 comprises a first cold cathode fluorescent lamp 521 and a second cold cathode fluorescent lamp 522. And, the first secondary coil 5112 of the first transformer 511 and the second secondary coil 5122 of the second transformer 512 are coupled to the first cold cathode fluorescent lamp 521 and the second cold cathode fluorescent lamp 522 of the lamp apparatus 52 respectively.

Please refer to FIG. 4A again. As shown in FIG. 4A, the high-voltage signal 54 is inputted to one end of the first secondary coil 5112 of the first transformer 511 and the second secondary coil 5122 of the second transformer 512 respectively. Specially, in this embodiment, the high-voltage signal 54 is a triangular wave, but not limited to this.

When the high-voltage signal 54 is inputted to one end of the first secondary coil 5112 of the first transformer 511 and one end of the second secondary coil 5122 of the second transformer 512 respectively, the first secondary coil 5112 and the second secondary coil 5122 will induct the high-voltage signal 54 on the first primary coil 5111 and the second primary coil 5121. Because the first primary coil 5111 is connected to the second primary coil 5121 in series, so that the current flowing through the first secondary coil 5112 will be forced to be the same with the current flowing through the second secondary coil 5122, and the inductive signal will be sent to the lamp apparatus 52. Thus, the brightness of the light emitted from the first cold cathode fluorescent lamp 521 will be approximately the same with the brightness of the light emitted from the second cold cathode fluorescent lamp 522.

Please refer to FIG. 4B. FIG. 4B illustrates a schematic diagram of the multi-lamp driving circuit 5 connected in series in FIG. 4A. As shown in FIG. 4B, one set of multi-lamp driving circuit 6 is additionally connected to the multi-lamp driving circuit 5 of FIG. 4A in series. It should be noticed that the structures of the multi-lamp driving circuit 6 and the multi-lamp driving circuit 5 are the same; however, for convenience of explanation, the different marks are given in the illustration.

In this embodiment, the multi-lamp driving circuit 5 is connected to the multi-lamp driving circuit 6 in series. And, the second primary coil 5121 of the multi-lamp driving circuit 5 is connected to the first primary coil 6111 of the multi-lamp driving circuit 6 in series. Additionally, one end of the first secondary coil 5112 and one end of the second secondary coil 5122 of the multi-lamp driving circuit 5, one end of the first secondary coil 6112 and one end of the second secondary coil 6122 of the multi-lamp driving circuit 6 are mutually electrically connected and receive the high-voltage signal 54. And, the other end of the first secondary coil 5112 and the other end of the second secondary coil 5122 of the multi-lamp driving circuit 5 are electrically connected to the first cold cathode fluorescent lamp 521 and the second cold cathode fluorescent lamp 522 of the lamp apparatus 52, and the other end of the first secondary coil 6112 and the other end of the second secondary coil 6122 of the multi-lamp driving circuit 6 are electrically connected to the first cold cathode fluorescent lamp 621 and the second cold cathode fluorescent lamp 622 of the lamp apparatus 62. Please note that the multi-lamp driving circuit 5 and the multi-lamp driving circuit 6 are connected in series. Therefore, when the high-voltage signal 54 is inputted, the brightness of the lights emitted from the first cold cathode fluorescent lamp 521 and the second cold cathode fluorescent lamp 522 of the lamp apparatus 52 and the first cold cathode fluorescent lamp 621 and the second cold cathode fluorescent lamp 622 of the lamp apparatus 62 will be approximately the same.

Specially, the above-mentioned part is related to the method of connecting the multi-lamp driving circuit 5 with other multi-lamp driving circuit in series to get the same brightness from different lamp apparatuses. Thus, the amount of the multi-lamp driving circuits connected to the multi-lamp driving circuit 5 in series is not limited to one; it depends on the requirement of the user.

Although the present invention has been illustrated and described with reference to the preferred embodiment thereof, it should be understood that it is in no way limited to the details of such embodiment but is capable of numerous modifications within the scope of the appended claims.

What is claimed is:

1. A combined transformer, comprising:
a first core, the first core having a first side pillar, a first middle pillar, and a second side pillar, wherein the first middle pillar, the first side pillar, and the second pillar are connected;
a second core, the second core having a second middle pillar butting to the first middle pillar, a third side pillar butting to the first side pillar, and a fourth side pillar butting to the second side pillar, wherein the second middle pillar, the third side pillar, and the fourth side pillar are connected;
a first primary coil, wound on the first side pillar of the first core;
a first secondary coil, wound on the third side pillar of the second core, and the first secondary coil corresponding to the first primary coil;
a second primary coil, wound on the second side pillar of the first core; and
a second secondary coil, wound on the fourth side pillar of the second coil, and the second secondary coil corresponding to the second primary coil;
wherein the mutually butted first side pillar and third side pillar and the mutually butted first middle pillar and second middle pillar form a first magnetic path; the mutually butted second side pillar and fourth side pillar and the mutually butted first middle pillar and second middle pillar form a second magnetic path; the first primary coil, the first secondary coil, and the first magnetic path form a first transformer; and the second primary coil, the second secondary coil, and the second magnetic path form a second transformer.

2. The combined transformer of claim 1, wherein the first primary coil is wound on a first plastic shell and set on the first side pillar, and the second primary coil is wound on a second plastic shell and set on the second side pillar.

3. The combined transformer of claim 1, wherein the first secondary coil is wound on the first plastic shell and set on the third side pillar, and the second secondary coil is wound on the second plastic shell and set on the fourth side shell.

4. A multi-lamp driving circuit, used for receiving a high-voltage signal to supply a lamp apparatus, the multi-lamp driving circuit comprising:
a first core, the first core having a first side pillar, a first middle pillar, and a second side pillar, wherein the first middle pillar, the first side pillar, and the second pillar are connected;
a second core, the second core having a second middle pillar butting to the first middle pillar, a third side pillar butting to the first side pillar, and a fourth side pillar butting to the second side pillar, wherein the second middle pillar, the third side pillar, and the fourth side pillar are connected;
a first primary coil, wound on the first side pillar of the first core;
a first secondary coil, wound on the third side pillar of the second core, and the first secondary coil corresponding to the first primary coil;
a second primary coil, wound on the second side pillar of the first core; and
a second secondary coil, wound on the fourth side pillar of the second coil, and the second secondary coil corresponding to the second primary coil;
wherein the mutually butted first side pillar and third side pillar and the mutually butted first middle pillar and second middle pillar form a first magnetic path; the mutually butted second side pillar and fourth side pillar and the mutually butted first middle pillar and second middle pillar form a second magnetic path; the first primary coil, the first secondary coil, and the first magnetic path form a first transformer; the second primary coil, the second secondary coil, and the second magnetic path form a second transformer; the first primary coil and the second primary coil form a series loop; one end of the first secondary coil and one end of the second secondary coil receive the high-voltage signal respectively; and the other end of the first secondary coil and the other end of the second secondary coil couple to the lamp apparatus respectively.

5. The multi-lamp driving circuit of claim 4, wherein the first primary coil is wound on a first plastic shell and set on the first side pillar, and the second primary coil is wound on a second plastic shell and set on the second side pillar.

6. The multi-lamp driving circuit of claim 4, wherein the first secondary coil is wound on the first plastic shell and set on the third side pillar, and the second secondary coil is wound on the second plastic shell and set on the fourth side shell.

7. The multi-lamp driving circuit of claim 4, wherein the lamp apparatus comprises a first cold cathode fluorescent lamp and a second cold cathode fluorescent lamp;
the first secondary coil and the second secondary coil are coupled to the first cold cathode fluorescent lamp and the cold cathode fluorescent lamp respectively.
